(19) United States
(12) Patent Application Publication
(10) Pub. No.: US 2025/0351207 A1
(43) Pub. Date: Nov. 13, 2025

(54) SYSTEMS AND METHODS FOR PROVIDING MULTIMEDIA PRIORITY SUBSCRIPTION ENFORCEMENT PER SERVICE

(71) Applicant: Verizon Patent and Licensing Inc., Basking Ridge, NJ (US)

(72) Inventors: Shanthala Kuravangi-Thammaiah, Keller, TX (US); Robert Avanes, Roanoke, TX (US); Toby Varughese John, Murphy, TX (US)

(21) Appl. No.: 18/659,425

(22) Filed: May 9, 2024

(51) Int. Cl. H04W 76/11; H04W 8/18

(52) U.S. Cl. CPC H04W 76/11; H04W 8/18

(57) ABSTRACT

Systems and methods provide a per-session Multimedia Priority Service (MPS) enforcement service. A network device in a wireless core network receives, from a user equipment (UE) device, a registration request including a request for high priority access. The network device obtains subscriber profile data for the UE device, wherein the subscriber profile data includes parameters for granular MPS service priority. The network device provides, to the UE device, a registration response based on the subscriber profile data and receives, from the UE device, a session establishment request to establish a protocol data unit (PDU) session. The network device sends, based on the session establishment request, context data to a session management function (SMF) for the PDU session, wherein the context data includes the parameters for the granular MPS service priority.

### BACKGROUND

Multimedia Priority Service (MPS) is a service that delivers calls or sessions of a high priority nature from mobile to mobile networks, mobile to fixed networks, and fixed to mobile networks. The intention of MPS is to enable National Security (NS) or Emergency Preparedness (EP) users to conduct priority calls/sessions using public networks during network congestion. MPS users, such as NS or EP users, include government-authorized personnel, emergency management officials, and/or other authorized users. Effective emergency/disaster response and management may rely on an MPS user's ability to communicate during network congestion. Therefore, MPS users expect to receive priority treatment in support of multimedia communications.

### BRIEF DESCRIPTION OF THE DRAWINGS

FIG. 1 is a diagram illustrating an example network environment consistent with an embodiment;

FIG. 2 is a block diagram of a portion of a network environment including components for a per-session MPS enforcement service, according to an implementation;

FIG. 3 is a table illustrating example associations of priority levels with MPS for the per-session MPS enforcement service;

FIG. 4 is a signal flow diagram illustrating example communications for the per-session MPS enforcement service in a portion of a network environment, according to an implementation;

FIG. 5 is a flow chart of an exemplary process for the per-session MPS enforcement service; and

FIG. 6 is a block diagram illustrating example components of a device 600 that may correspond to one or more of the devices described herein.

### DETAILED DESCRIPTION

The following detailed description refers to the accompanying drawings. The same reference numbers in different drawings may identify the same or similar elements. The following detailed description does not limit the scope of the invention.

Telecommunication advancements have led to increases in the numbers and utilization of User Equipment (UE) devices, including mobile communication handsets (e.g., smart phones) and Internet of Things (IoT) devices. The increasing number of devices exchanging data with wireless networks can present risks affecting the performance and availability of different services. For example, during an emergency and/or periods of high use, access to wireless connectivity may become restricted due to congestion on the wireless channels, and thus impact public safety and/or security.

For example, network operators in the United States currently support elevated priority services for National Security (NS) and Emergency Preparedness (EP) subscribers, which include voice, data, and other wireless communication services. Design and feature implementations deployed in many networks provide priority to NS/EP subscribers over normal users in the radio access network (RAN), evolved packet core (EPC), and in Internet Protocol multimedia systems (IMS). Elevated priority services, which may include multimedia priority services (MPS), may be subscribed services for prioritized access to a cellular network. Sessions designated for high priority services may be collectively referred to herein as “MPS sessions.”

Third generation partnership project (3GPP) standards and network service providers define access requirements for high priority subscribers to gain access to a cellular network in a crisis event where networks are congested. Currently, Fifth Generation (5G) network standards allow subscription-based priority for MPS but do not provide options for the granularity required to serve some 5G use cases. More particularly, service providers for 5G networks are not able to limit MPS priority to, for example, only voice, data, text (e.g., short message service (SMS)), or other application functions at the subscription level. Thus, service providers may not be able to distinguish between application functions that need priority or do not need priority for the same MPS subscriber. For example, with current 5G network connections, traffic from non-critical applications (e.g., social media traffic) for an MPS subscriber may be given the same priority as critical traffic (e.g., applications associated with federal services).

Systems and methods described herein provide for MPS enforcement per service. MPS subscription data is enhanced to provide granularity for MPS services. The systems and methods provide MPS subscription enforcement per network service and granularity with respect to the application function level. Service providers may prevent all application functions for an MPS subscriber from receiving the same priority, thereby preventing unnecessary network consumption during periods of network congestion. The different MPS priority levels may be identified during protocol data unit (PDU) session establishment.

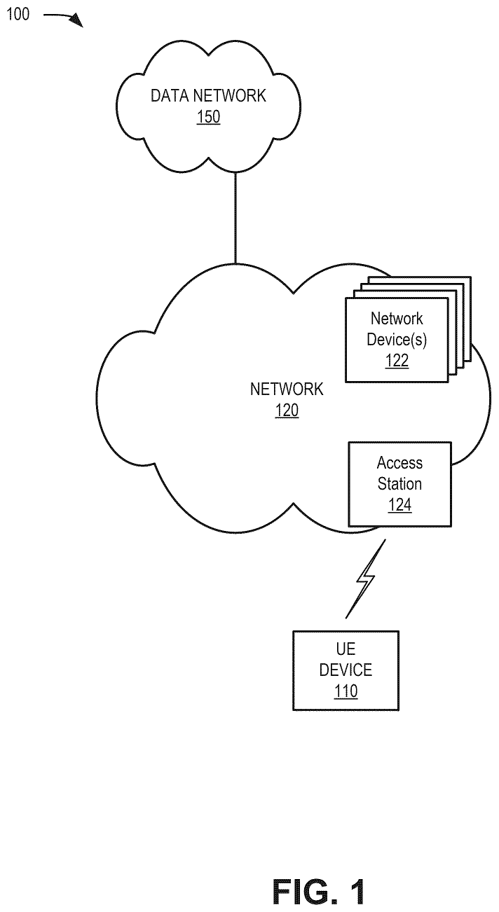

FIG. 1 provides an overview of a network environment 100 in which a per-session MPS enforcement service may be implemented. As shown, network environment 100 may include a UE device 110, a network 120, and a data network 150.

UE device 110 may include a wireless communication device. Examples of UE device 110 include a cellular telephone device (e.g., a conventional cell phone with data processing capabilities), a smart phone, a personal digital assistant (PDA) that can include a radiotelephone, a wearable computer (e.g., a smart watch), a vehicle telematics system, an Internet-of-Things (IoT) device, etc. UE device 110 may access network 120 in accordance with subscription parameters, which may include MPS subscription parameters.

Network 120 may include a network of a wireless carrier that is associated with UE device 110 via a subscription. Network 120 may be a default/primary network for providing service to UE device 110. Network 120 may include, for example, a RAN, a core network, and other networks. For example, network 120 may include a local area network (LAN), a wireless LAN, a wide area network (WAN), a metropolitan area network (MAN), an optical network, a cable television network, a satellite network, a wireless network (e.g., a Code Division Multiple Access (CDMA) network, a general packet radio service (GPRS) network, a Long Term Evolution (LTE) network (e.g., 4G network), a 5G network, a Sixth Generation (6G) or future network, an ad hoc network, a telephone network (e.g., the Public Switched Telephone Network (PSTN) or a cellular network), an intranet, or a combination of networks. Network 120 may allow the delivery of Internet Protocol (IP) services to UE device 110 and may interface with and/or include other networks, such as a data network 150.

Depending on the implementation, network 120 may include one or multiple types of network devices 122. For example, network devices 122 may include RAN devices, such as a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a distributed unit (DU), a small cell node (e.g., a picocell device, a femtocell device, a microcell device, a home eNB, a home gNB, etc.), a 5G ultra-wide band (UWB) node, a future generation wireless access device (e.g., a 6G wireless station or another generation of wireless station). In the illustration of FIG. 1, an access station 124, which may include one of network devices 122, may establish a wireless connection with UE device 110 to network 120.

In other implementations, network devices 122 may include network devices for a wireless core network, such as an access and mobility management function (AMF), a session management function (SMF), a unified data management (UDM) device, a unified data repository (UDR), a user plane function (UPF), an application function (AF), a charging function (CHF), a binding support function (BSF), a Call Session Control Function (CSCF), a network data analytics function (NWDAF), an authentication server function (AUSF), a security anchor function (SEAF), a network slice selection function (NSSF), a network repository function (NRF), a policy control function (PCF), a network exposure function (NEF), and/or a service capability exposure function (SCEF). According to other implementations, network devices 122 may include additional, different, and/or fewer network devices than those described. For example, some functions may be divided into sub-components, such as a session management (SM)-PCF, a user equipment (UE)-PCF, and an access and mobility (AM)-PCF. Also, network device 122 may include a gateway, a router, a switch, a firewall, a bridge, a proxy server, a server, or some other type of device that processes and/or transfers data.

Data network 150 may include, for example, a packet data network. In an implementation, UE device 110 may connect to data network 150 via network 120. Data network 150 may also include and/or be connected to a LAN, a WAN, a MAN, an autonomous system (AS) on the Internet, an optical network, a cable television network, a satellite network, a wireless network, an ad hoc network, a telephone network (e.g., the PSTN or a cellular network), an intranet, or a combination of networks. Although a single data network 150 is shown in FIG. 1 for simplicity, in practice there may be numerous data networks 150 which may be connected with UE device 110 at the same time via different sessions. Using the per-session MPS enforcement service network devices 122 may enable parameters for granular MPS service priority to be enforced on individual sessions (e.g., for different types of network services, such as voice, text, data, or other applications) rather than for all sessions of an MPS-enabled UE device 110.

The number of devices, the number of networks, and the configuration in environment 100 are exemplary. According to other embodiments, environment 100 may include additional devices, fewer devices, and/or differently arranged devices, than those illustrated in FIG. 1. For example, according to other embodiments, environment 100 may include additional wired and/or wireless networks.

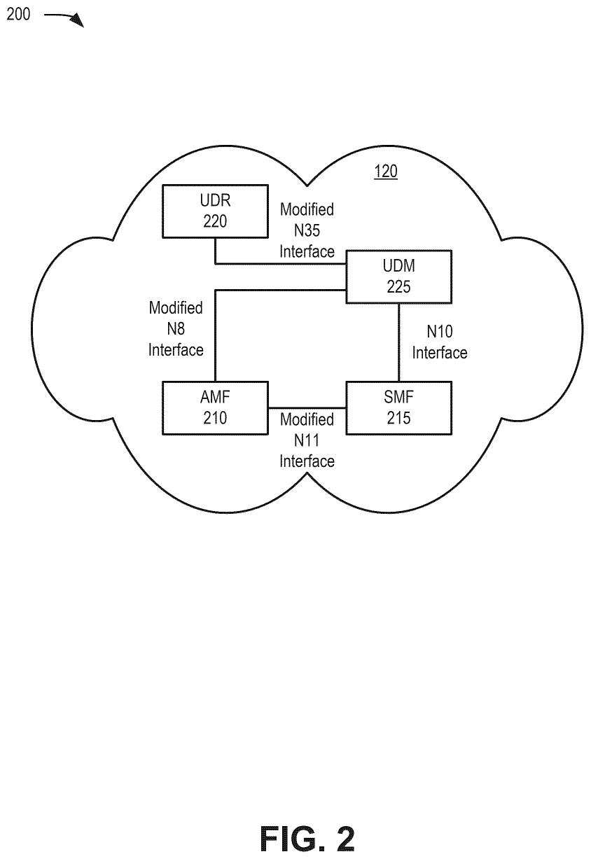

FIG. 2 is a diagram of a portion 200 of network environment 100 including components of network 120 for the per-session MPS enforcement service, according to an implementation. As shown in FIG. 2, network 120 may include an AMF 210, an SMF 215, a UDR 220, and a UDM 225. Each of AMF 210, SMF 215, UDR 220, and UDM 225 includes, or is executed by, a network device (e.g., network device 122).

AMF 210 may perform UE-based authentication, authorization, and mobility management for UE devices 110. AMF 210 may also perform registration management, lawful intercepts, Short Message Service (SMS) transport, session management message transport between UE device 110 and SMF 215, access authentication and authorization, location services management, functionality to support non-3GPP access networks, and/or other types of management processes. For the per-session MPS enforcement service, AMF 210 may receive a priority request from UE device 110 during a registration process and retrieve subscription data from UDM 225. As described further herein, the subscription data may include a subscriber's MPS service priority for voice, SMS, SMS over non-access stratum (NAS), data, and/or other services. AMF 210 may be configured to support and interpret the different MPS service priority types in the subscription data. As shown in FIG. 2, AMF 210 may use a modified N8 interface or Nudm interface, for example, to retrieve the subscriber's MPS service priority data. After registration, AMF 210 may receive a request from a UE device 110 to connect to a data network 150 using a data network name (DNN). When AMF 210 receives a session establishment request from UE device 110, AMF 210 may select an appropriate SMF 215 for the session and provide context data, including the subscription granularity for the per-session MPS enforcement service on the DNN, towards the SMF 215. AMF 215 may use a modified N11 interface or Nsmf interface, for example, to provide the subscriber's MPS service priority in the context data.

SMF 215 may perform session establishment, session modification, and/or session release, perform IP address allocation and management, perform Dynamic Host Configuration Protocol (DHCP) functions, perform selection and control of a UPF, configure traffic steering at the UPF to guide the traffic to the correct destinations, terminate interfaces toward a PCF, perform lawful intercepts, charge data collection, support charging interfaces, control and coordinate charging data collection, perform downlink data notification, manage roaming functionality, and/or perform other types of control plane processes for managing user plane data. For the per-session MPS enforcement service, SMF 215 may receive (e.g., via the modified N11 interface) context data from AMF 210, including the subscription granularity for the per-session MPS enforcement service, on the requested DNN. SMF 215 may verify the DNN and Application Function ID (AFID) associated with the DNN which are subjected to priority service and may request the priority only for those services or AFIDs on that DNN. SMF 215 may initiate priority sessions towards UDM 225 and an appropriate SM-PCF (not shown) based on the information in the context data received from AMF 210.

UDR 220 may provide a unified data structure that is accessible to a number of functional elements in network 120. For example, UDR 220 may support storage and retrieval of subscription data by UDM 225 among others. According to implementations described herein, UDR 220 may store a subscriber profile that includes parameters for granular MPS service priority for the per-session MPS enforcement service. According to one implementation, UDR 220 may provide the granular MPS service priority to UDM 225 during a UE registration process. For example, UDR 220 may use a modified N35 interface or Nudr interface to provide the parameters for granular MPS service priority.

UDM 225 may maintain subscription information for UE devices 110, manage subscriptions, generate authentication credentials, handle user identification, perform access authorization based on subscription data, perform network function registration management, maintain service and/or session continuity by maintaining assignment of SMF 215 for ongoing sessions, support SMS message delivery, support lawful intercept functionality, and/or perform other processes associated with managing user data. According to implementations described herein, UDM 225 may retrieve from UDR 220 a subscriber profile that includes a granular MPS service priority for the per-session MPS enforcement service. As shown in FIG. 2, UDM 225 may use a modified N35 interface, for example, to retrieve the subscriber's MPS service priority data from UDR 220.

FIG. 2 illustrates exemplary components of network portion 200 to support the per-session MPS enforcement service. According to other exemplary embodiments, additional components, fewer components, and/or different components than those illustrated and described may be used to provide the per-session MPS enforcement service. Additionally, or alternatively, according to other embodiments, multiple components may be combined into a single component.

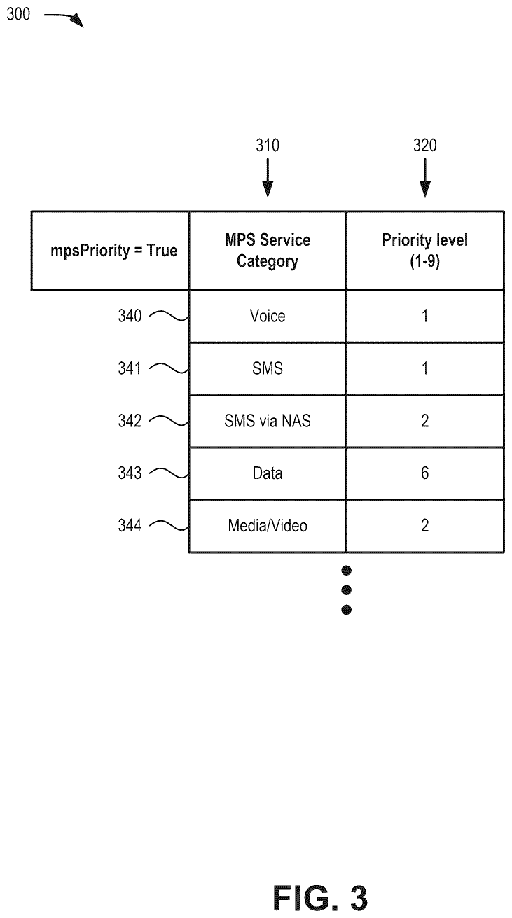

FIG. 3 is a table 300 illustrating example associations of priority levels with MPS for the per-session MPS enforcement service. Table 300 may include information to supplement existing categorical input type for MPS priority (e.g., a Boolean that indicates whether a UE device is subscribed to MPS) and may be associated with a subscriber profile (e.g., stored in UDR 220). Table 300 may include an MPS service category field 310, a priority level field 320, and a variety of entries 340-344. Table 300 is a simplified example of parameters that may be used with the per-session MPS enforcement service.

As shown in FIG. 3, MPS service category field 310 may include a type of service that may use MPS, such as Voice, SMS, SMS over NAS, Data, and Media/Video. In other implementations, additional and/or different service categories may be used. Priority level field 320 may indicate a priority level associated with the corresponding category in field 310. Priority level field 320 may indicate, for example, whether a UE device 110 with an MPS subscription will receive a high priority treatment for a particular service category. In the example of FIG. 3, priority levels assigned to a service category may range from 1 (highest priority) to 9 (lowest priority). In other implementations, different priority indicators and different ranges may be used (e.g., high, medium, low, etc.)

In table 300, entry 340 associates a service category (i.e., “Voice”) with a subscriber-specific priority level (i.e., “1”) which allows voice calls to/from UE device 110 to receive highest priority treatment under MPS. Entry 341 associates another service category (i.e., “SMS”) with a subscriber-specific priority level (i.e., “1”) which allows text messages to/from UE device 110 to receive highest priority treatment under MPS. Entry 342 associates still another service category (i.e., “SMS via NAS”) with a subscriber-specific priority level (i.e., “2”) which allows text messages using an NAS control channel to receive slightly lower priority treatment under MPS than Voice and SMS. Entry 343 associates yet another service category (i.e., “Data”) with a subscriber-specific priority level (i.e., “6”) which causes UE data sessions to have lower priority treatment under MPS (e.g., relative to Voice, SMS, or SMS via NAS traffic). Entry 344 associates another service category (i.e., “Media/Video”) with a subscriber-specific priority level (i.e., “2”) which causes sessions for video streams and the like to have relative priority treatment under MPS (e.g., slightly below Voice and SMS, but higher than other data traffic).

MPS classifications from table 300 may be included in a subscriber's profile and provided to AMF 210 during a registration process. During a PDU session establishment, AMF 210 may include the MPS classifications with other context data that is provided, for example, to a selected SMF 215 for the PDU session.

Table 300 shows one arrangement of example parameters that may be used with the per-session MPS enforcement service. In other implementations, table 300 may include different, additional, or fewer parameters than those illustrated. For example, additional MPS service categories may be included to provide priority for other selected application functions (e.g., location tracking functions, mapping functions, etc.). Furthermore, parameters of table 300 may be provided in a different format or data structure (e.g., a list, database, flat file, etc.) in other implementations.

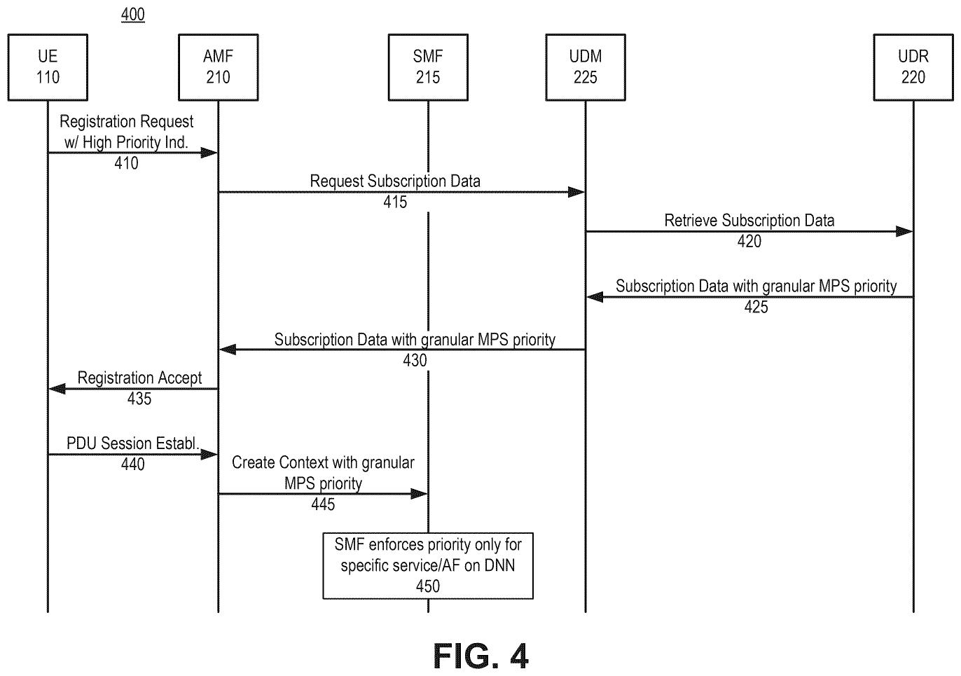

FIG. 4 is a diagram illustrating exemplary communications for the per-session MPS enforcement service in a portion 400 of network environment 100, according to an implementation. Network portion 400 may include UE device 110, AMF 210, SMF 215, UDR 220, and UDM 225. FIG. 4 provides a simplified illustration of communications in network portion 400 and is not intended to reflect every signal, communication, or intermediate points for exchanges between functions/devices.

As shown in FIG. 4, a UE device 110 may submit to AMF 210 (e.g., via an access station 124, not shown) a registration request 410, with a request for high priority access, to network 120. For example, UE device 110 may send a priority request with a priority indicator to the AMF 210 during a registration process. AMF 210 may receive registration request 410 with the priority indicator. In response, AMF 210 may provide a request 415 to obtain from UDM 225 subscription data (e.g., access management data) for UE device 110. For example, AMF 215 may send an HTTP GET request (e.g., GET ../nudm-sdm/v./{supi}/am-data) to UDM 225 using an N8 interface. UDM 225 may receive request 415 and, in response, may retrieve 420 from UDR 220 the requested subscription data. For example, UDM 225 may send an HTTP GET request (e.g., GET {servingPlmnId}/provisioned-data/am-data) to UDR 220 using an N35 interface.

According to implementations described herein, subscription data in UDR 220 may include granular MPS service priority to support the per-session MPS enforcement service. For example, subscription data in UDR 220 may include, for each account having MPS, MPS service categories (e.g., Voice, SMS, SMS over NAS, Data, Media/Video, etc.) and a corresponding priority level per service category (e.g., levels 1 to 9 or another type of level indicator). Accordingly, UDR 220 may provide subscription data with granular MPS priority to UDM 225. For example, UDR 220 may provide an HTTP OK message 425 with granular MPS priority information (e.g., 200 OK {voice 1, SMS 1, SMS_over_NAS 2, . . . }) to UDM 225. In one implementation, the N35 interface may be modified to accommodate transmitting the granular MPS priority information from UDR 220 to UDM 225. UDM 225 may forward 430 to AMF 210 the subscription data with granular MPS priority. In one implementation, the N8 interface may be modified to accommodate transmitting the granular MPS priority information from UDM 225 to AMF 210. Assuming the UE device 110 is authorized to connect to network 100, AMF 210 may provide a registration accept message 435 to UE device 110, based on the subscription data received from UDM 225.

After successful registration, UE device 110 may request a new PDU session for a DNN. For example, UE device 110 may submit to AMF 210 a PDU session establishment request 440. In response to PDU session establishment request 440, AMF 210 may select an SMF (e.g., SMF 215) for the requested session and may initiate SMF context creation request 445 for the DNN. Context creation information may include the DNN, Single Network Slice Selection Assistance Information (S-NSSAI), and a PDU Session ID. As part of the context creation, AMF 210 may also provide to SMF 215 the granular MPS service priority to support the per-session MPS enforcement service on that DNN. For example, AMF 210 may provide a HTTP POST message with granular MPS priority information (e.g., Post./nsmf-pdusession/../ sm-contexts(SmContextCreateData)) to UDM 225. In one implementation, the N11 interface may be modified to accommodate transmitting the granular MPS priority information from AMF 210 to SMF 215.

SMF 215 may receive the context data, including the granular MPS service priority, from context creation request 445 and may verify the DNN and Application Function (AF) ID associated with the DNN that are subjected to priority service. As shown at reference 450, SMF 215 may enforce priority only for those services or AF IDs on that DNN. SMF 215 may initiate priority sessions towards UDM 225 and an SM-PCF (not shown) based on the information in context data. UDM 225 and the SM-PCF may utilize this priority session for further communication with UDR 220 and other network functions (e.g., CHF, BSF, CSCF, etc.).

FIG. 4 illustrates example communications for an SMF to enact per-session MPS enforcement based on granular MPS priority data from an AMF. In other implementations, AMF 210 may share granular MPS priority data with a Short Message Service Function (SMSF), a UE-PCF, or other network devices 122 in addition to SMF 215. Recipients of the granular MPS priority data (e.g., SMF, SMSF, UE-PCF, etc.) may be referred to herein collectively as consumer functions.

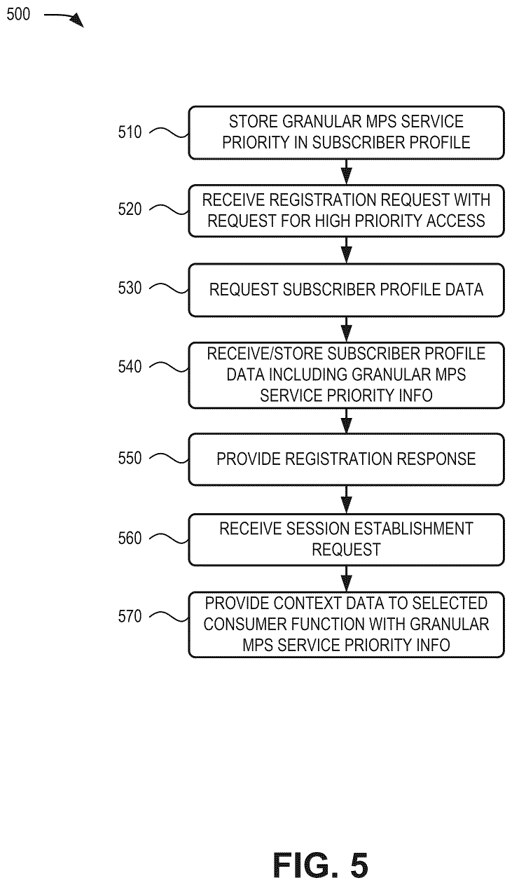

FIG. 5 is a flow chart of an exemplary process 500 for the per-session MPS enforcement service. In an embodiment, process 500 may be performed by one or more network devices 122, such as AMF 210 and SMF 215. In other embodiments, process 500 may be performed by UE device 110 in conjunction with one or more network devices 122.

Process 500 may include storing granular MPS service priority in a subscriber profile (block 510) and receiving a registration request with a request for high priority access (block 520). For example, as part of a new or updated subscription process, a subscriber profile may be stored in UDR 220. The subscriber profile may include parameters for the per-session MPS enforcement service. For example, the subscriber profile may include an MPS priority indicator (e.g., true/false) and service priority settings for those subscribers that have MPS priority (e.g., as described in connection with FIG. 3). At some time after the subscription is activated, AMF 210 may receive a registration request, with a high priority access indicator, from a UE device 110.

Process 500 may also include requesting subscriber profile data (block 530) and receiving subscriber profile data including granular MPS service priority information for the subscriber (block 540). For example, as described above in connection with FIG. 4, AMF 210 may perform access/authentication procedures including requesting access management data from the subscriber profile associated with UE device 110. UDM 225 may retrieve, from UDR 220, the subscriber profile data, which includes granular MPS service priority parameters for UE device 110, and forward the subscriber profile data to AMF 210. AMF 210 may temporarily store the granular MPS service priority data for future context creation with an SMF, for example.

Process 500 may further include providing a registration response to the UE device (block 550) and receiving a session establishment request from the UE device (block 560). For example, assuming the UE device 110 is authorized to access the network, AMF 210 may provide a registration response to UE device 110 enabling network access. UE device 110 may later follow with a session establishment request for a PDU session with a certain DNN (e.g. associated with a data network 150).

Process 500 may additionally include providing context data to a selected consumer function with granular MPS service priority information (block 570). For example, in response to the session establishment request from UE device 110, AMF 210 may initiate SMF context creation for the DNN. As part of the context creation, AMF 210 may also provide to SMF 215 the granular MPS service priority to support the per-session MPS enforcement service on that DNN. SMF 215 may receive the context data and use the granular MPS service priority parameters to enforce priority for specific services and/or functions on the DNN, such as provide high priority services for voice and data sessions for UE device 110.

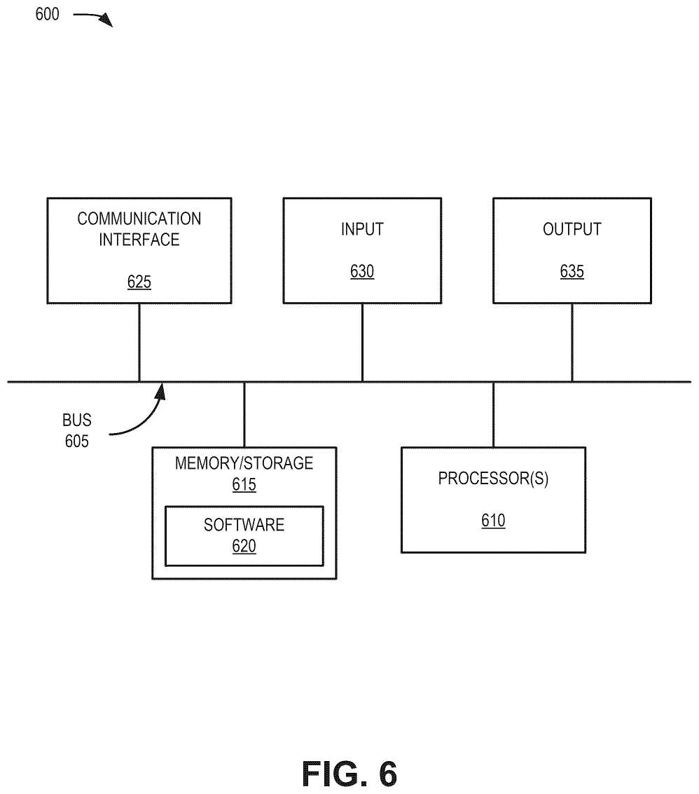

FIG. 6 is a diagram illustrating exemplary components of a device 600 that may correspond to one or more of the devices described herein. For example, device 600 may correspond to components included in UE devices 110, network 120, network devices 122, and/or other elements illustrated in FIGS. 1 and 2. As illustrated in FIG. 6, according to an exemplary embodiment, device 600 includes a bus 605, one or more processors 610, memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, and/or clocks.

Processor 610 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc. Processor 610 may be a dedicated component or a non-dedicated component (e.g., a shared resource).

Processor 610 may control the overall operation or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques including, for example, multithreading, parallel processing, pipelining, interleaving, etc.

Memory/storage 615 includes one or multiple memories and/or one or multiple other types of storage mediums. For example, memory/storage 615 may include one or multiple types of memories, such as, random access memory (RAM), dynamic random-access memory (DRAM), cache, read only memory (ROM), a programmable read only memory (PROM), a static random-access memory (SRAM), a single in-line memory module (SIMM), a dual in-line memory module (DIMM), a flash memory (e.g., a NAND flash, a NOR flash, etc.), and/or some other type of memory. Memory/storage 615 may include a hard disk (e.g., a magnetic disk, an optical disk, a magneto-optic disk, a solid-state disk, etc.), a Micro-Electromechanical System (MEMS)-based storage medium, and/or a nanotechnology-based storage medium. Memory/storage 615 may store data, software, and/or instructions related to the operation of device 600.

Software 620 includes an application or a program that provides a function and/or a process. Software 620 may include an operating system. Software 620 is also intended to include firmware, middleware, microcode, hardware description language (HDL), and/or other forms of instruction.

Communication interface 625 permits device 600 to communicate with other devices, networks, systems, devices, and/or the like. Communication interface 625 includes one or multiple wireless interfaces and/or wired interfaces. For example, communication interface 625 may include one or multiple transmitters and receivers, or transceivers (e.g., radio frequency transceivers). Communication interface 625 may include one or more antennas. For example, communication interface 625 may include an array of antennas. Communication interface 625 may operate according to a protocol stack and a communication standard. Communication interface 625 may include various processing logic or circuitry (e.g., multiplexing/de-multiplexing, filtering, amplifying, converting, error correction, etc.).

Input 630 permits an input into device 600. For example, input 630 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 635 permits an output from device 600. For example, output 635 may include a speaker, a display, a light, an output port, and/or some other type of visual, auditory, tactile, etc., output component. According to some embodiments, input 630 and/or output 635 may be a device that is attachable to and removable from device 600.

Device 600 may perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions stored by memory/storage 615 cause processor 610 to perform a process described herein. Alternatively, for example, according to other implementations, device 600 performs a process described herein based on the execution of hardware (processor 610, etc.).

Systems and methods described herein provide a per-session MPS enforcement service. A network device in a wireless core network receives, from a UE device, a registration request including a request for high priority access. The network device obtains subscriber profile data for the UE device, wherein the subscriber profile data includes parameters for granular MPS service priority. The network device provides, to the UE device, a registration response based on the subscriber profile data and receives, from the UE device, a session establishment request to establish a PDU session. The network device sends, based on the session establishment request, context data to a selected SMF for the PDU session, wherein the context data includes the parameters for the granular MPS service priority. The PDU session may then be supported based on the MPS service priority.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIG. 5, and message flows with regard to FIG. 4, the order of the blocks and messages may be modified in other embodiments. Further, non-dependent messaging and/or processing blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

The terms “comprises” and/or “comprising,” as used herein specify the presence of stated features, integers, steps or components but does not preclude the presence or addition of one or more other features, integers, steps, components, or groups thereof. Further, the term “exemplary” (e.g., “exemplary embodiment,” “exemplary configuration,” etc.) means “as an example” and does not mean “preferred,” “best,” or likewise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, by a network device and from a user equipment (UE) device, a registration request including a request for high priority access;
obtaining, by the network device, subscriber profile data for the UE device, wherein the subscriber profile data includes parameters for granular multimedia priority service (MPS) service priority;
providing, by the network device and to the UE device, a registration response based on the subscriber profile data;
receiving, by the network device and from the UE device, a session establishment request to establish a protocol data unit (PDU) session; and
sending, by the network device and based on the session establishment request, context data to a consumer function for the PDU session, wherein the context data includes the parameters for the granular MPS service priority.

2. The method of claim 1, wherein the parameters for the granular MPS service priority include:
multiple types of network services associated with a subscriber, and
a priority level for each type of the types of network services.

3. The method of claim 2, wherein the multiple types of network services include one or more of:
voice service,
short message service (SMS),
SMS over non-access stratum (NAS) service, or
data service.

4. The method of claim 1, wherein obtaining the parameters includes:
sending, from the network device and to a unified data management (UDM) function, a request for access management data relating to the UE device, and
receiving, from the UDM function, an MPS priority indicator and the parameters for the granular MPS service priority.

5. The method of claim 4, wherein obtaining the parameters further includes:
sending, by the UDM function, a request for access management data relating to the UE device; and
receiving, from a unified data repository (UDR) function, the MPS priority indicator and the parameters for the granular MPS service priority.

6. The method of claim 1, further comprising:
enforcing, by the consumer function, the MPS service priority for selected services accessed by the UE device, based on the parameters.

7. The method of claim 1, further comprising:
storing, by a unified data repository (UDR) function, the subscriber profile data with the parameters for granular MPS service priority.

8. The method of claim 1, wherein the network device comprises an access and mobility management function (AMF), and wherein the consumer function comprises a session management function (SMF).

9. A network device, comprising:
a processor configured to:
receive, from a user equipment (UE) device, a registration request including a request for high priority access;
obtain subscriber profile data for the UE device, wherein the subscriber profile data includes parameters for granular multimedia priority service (MPS) service priority;
provide, to the UE device, a registration response based on the subscriber profile data;
receive, from the UE device, a session establishment request to establish a protocol data unit (PDU) session; and
send, based on the session establishment request, context data to a session management function (SMF) for the PDU session, wherein the context data includes the parameters for the granular MPS service priority.

10. The network device of claim 9, wherein the parameters for the granular MPS service priority include:
multiple types of network services associated with a subscriber, and
a priority level for each type of the types of network services.

11. The network device of claim 10, wherein the multiple types of network services include one or more of:
voice service,
short message service (SMS),
SMS over non-access stratum (NAS) service,
data service, or
an application function (AF).

12. The network device of claim 9, wherein, when obtaining the parameters, the processor is further configured to:
send, to a unified data management (UDM) function, a request for access management data relating to the UE device, and
receive, from the UDM function, an MPS priority indicator and the parameters for the granular MPS service priority.

13. The network device of claim 12, wherein, when receiving the MPS priority indicator and the parameters for the granular MPS service priority, the processor is further configured to:
receive the MPS priority indicator and the parameters for the granular MPS service priority via an N8 interface.

14. The network device of claim 9, wherein the network device comprises an access and mobility management function (AMF).

15. The network device of claim 9, wherein the processor is further configured to:
store the parameters for the granular MPS service priority associated with the UE device.

16. A non-transitory computer-readable medium comprising instructions, which, when executed by a processor of a network device, cause the processor to:
receive, from a user equipment (UE) device, a registration request including a request for priority access;
obtain subscriber profile data for the UE device, wherein the subscriber profile data includes parameters for multimedia priority service (MPS) service priority;
provide, to the UE device, a registration response based on the subscriber profile data;
receive, from the UE device, a session establishment request to establish a protocol data unit (PDU) session; and
send, based on the session establishment request, context data to a session management function (SMF) for the PDU session, wherein the context data includes the parameters for the MPS service priority.

17. The non-transitory computer-readable medium of claim 16, wherein the parameters for the MPS service priority include:
multiple types of network services associated with a subscriber, and
a priority level for each type of the types of network services.

18. The non-transitory computer-readable medium of claim 16, wherein the instructions further cause the processor to:
store the parameters for the MPS service priority associated with the UE device.

19. The non-transitory computer-readable medium of claim 16, wherein the instructions to obtain the parameters, further include instructions to cause the processor to:
send, to a unified data management (UDM) function, a request for access management data relating to the UE device, and
receive, from the UDM function, an MPS priority indicator and the parameters for the MPS service priority.

20. The non-transitory computer-readable medium of claim 16, wherein the network device comprises an access and mobility management function (AMF).
